(19) United States
(12) Patent Application Publication
(10) Pub. No.: US 2015/0137052 A1
(43) Pub. Date: May 21, 2015

(54) REMOVABLE FLOOR JACK SADDLE

(71) Applicants: Michael T. DeKeuster, Mount Pleasant, WI (US); Christopher H. Potter, Mount Pleasant, WI (US); Brian A. Walesa, Hartford, WI (US)

(72) Inventors: Michael T. DeKeuster, Mount Pleasant, WI (US); Christopher H. Potter, Mount Pleasant, WI (US); Brian A. Walesa, Hartford, WI (US)

(21) Appl. No.: 14/497,803

(22) Filed: Sep. 26, 2014

Related U.S. Application Data
(60) Provisional application No. 61/904,738, filed on Nov. 15, 2013.

(51) Int. Cl. B66F 13/00; B66F 5/00

(52) U.S. Cl. CPC B66F 13/00; B66F 5/00
USPC 254/133 R

(57) ABSTRACT

Methods and systems involving a jack having removable and interchangeable saddles are disclosed for lifting vehicles and other items. The jack includes a saddle base having a retention member whereby the saddles can be interchanged for different vehicles or items without the use of special tools. For example, each saddle includes an engagement member having an indent therein for engagement with the retention member.

### CROSS REFERENCES TO RELATED APPLICATIONS

This application claims the benefit of U.S. Provisional Patent Application Serial No. 61/904,738, filed Nov. 15, 2013, entitled Removable Floor Jack Saddle, the content of which is incorporated herein by reference in its entirety.

### TECHNICAL FIELD

The present application relates to floor jack saddles. More particularly, the present application relates to interchangeable floor jack saddles that removably couple to a floor jack.

### BACKGROUND

A floor jack is used to lift a vehicle from the ground. A user can position the floor jack underneath a lift point and raise the vehicle at that point. Floor jacks can be powered by manual or automated means, and have become essential to the automotive repair industry.

Existing floor jacks include a saddle positioned on top of a base to apply pressure to the lift point and raise the vehicle. These saddles are universal such that one saddle is used on a variety of automobiles. This method is not specific to certain vehicle lift points and potential undercarriage damage could result. An alternative to the universal saddle is an adaptor that is loosely placed on top of the universal saddle. Although this solves the application-specific needs, it may fall off easily during transport. Additionally, the effective height of this solution may not be appropriate for some vehicles with a lower ground clearance.

Existing saddles are permanently or semi-permanently installed with fasteners that couple the saddle to the base that are removable using tools. This process involves multiple steps and may involve the use of special tools to change the saddles for a different make of automobile.

### SUMMARY

The present application relates to floor jacks with interchangeable saddles that can be removably coupled to a saddle base of the floor jack. For example, the saddles can be removably coupled to the jack through detent mechanisms including, e.g., pins or spring-biased balls. Changing the saddles can be effected by either removing the spring-biased member, or by turning a knob to unlock the floor jack saddle detention member maintaining the saddle in place. Accordingly, extensive steps and specialized tools are not required to change the saddle, and lifting of a vehicle can be achieved in an easier manner. The application also provides vehicle-specific adaptor configurations that mate directly to unique lift points on certain automobiles, minimizing potential damage. Each adaptor is specific to a particular vehicle or make, or semi-universal in design to accommodate a wide range of automotive applications.

In an embodiment, a mechanism for use in interchanging saddles of a jack is disclosed. The mechanism may include a detent retention mechanism in a saddle base of the jack. A saddle is adapted to engage the detent retention mechanism and removably couple the saddle to the saddle base. The saddle may include a lift portion including a lift point interface adapted to engage a lift point of a vehicle, and an engagement member extending from the lift portion and adapted to engage the detent retention mechanism and removably couple the saddle to the saddle base.

In another embodiment, a jack is disclosed. The jack may include a frame, a jacking mechanism coupled to the frame, wherein the jacking mechanism includes a handle and a lifting arm movable relative to the frame in response to movement of the handle. A saddle base may be coupled to the lifting arm, and a saddle may be adapted to removably couple to the saddle base. The saddle may include a lift portion including a lift point interface adapted to engage a lift point of a vehicle, and an engagement member extending from the lift portion and including an indent adapted to engage a retention member in the saddle base and removably couple the saddle to the saddle base.

### BRIEF DESCRIPTION OF THE DRAWINGS

For the purpose of facilitating an understanding of the subject matter sought to be protected, there are illustrated in the accompanying drawings embodiments thereof, from an inspection of which, when considered in connection with the following description, the subject matter sought to be protected, its construction and operation, and many of its advantages should be readily understood and appreciated.

FIG. 1 is a front perspective view of a jack according to embodiments of the present application.

FIG. 2 is a front perspective view of a saddle and saddle base detached from one another in accordance with embodiments of the present application.

FIG. 3 is a side sectional view of one embodiment of a saddle and a retention member according to the present application.

FIG. 4 is another embodiment of a saddle and retention member according to the present application.

FIG. 5 is yet another embodiment of a saddle and retention member according to the present application.

FIGS. 6A-11B disclose embodiments of the saddle according to the present application.

### DETAILED DESCRIPTION

While this application is susceptible of embodiments in many different forms, there are illustrated in the drawings, and herein described in detail, certain embodiments with the understanding that the present disclosure is to be considered as an exemplification of the principles of the application and is not intended to limit the broad aspect of the application to the embodiments illustrated.

The present application discloses a floor jack with interchangeable saddles. The saddles can be removably coupled to the jack through, for example, a detent mechanism to allow for easy removal or insertion of saddles for different makes or models of vehicles. Accordingly, different saddles can be used to lift the vehicle and can be interchanged without the requirement of a special tool or a lengthy removal process.

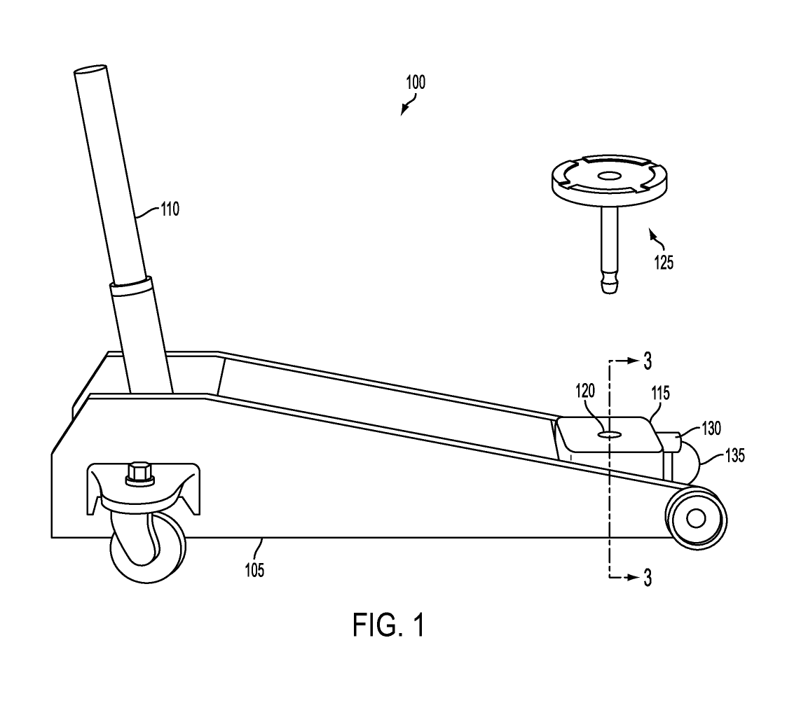

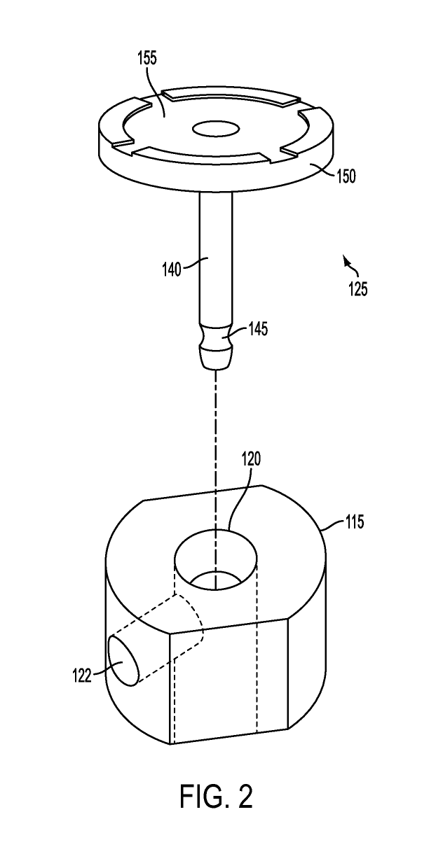

FIGS. 1 and 2 illustrate a jack 100 including a frame 105 and a jacking mechanism including a handle 110 operably coupled to a lifting arm that is movable relative to the frame 105 in response to motion of the handle 110. A saddle base 115 is coupled to the lifting arm and moves with the lifting arm in response to motion of the handle 110 to cause the saddle base 115 to raise a vehicle. The saddle base 115 may be installed and/or replace a current saddle base of the jack, for example using tools.

The saddle base 115 may include an opening 120 and side opening 122 angularly displaced, for example, by about 90 degrees, with respect to the opening 120. A saddle 125 can be inserted into the opening 120, and a retention member 130 can be inserted into or coupled to the side opening 122 to removably couple the saddle 125 to the saddle base 115. Wheels 135 can also be included to increase the mobility of the floor jack 100.

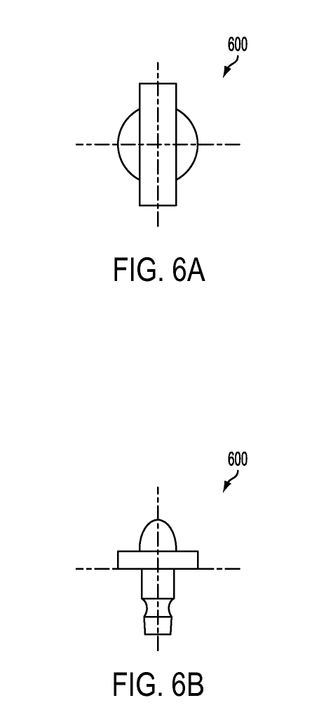

As illustrated in FIG. 2, the saddle 125 can include an engagement member 140 having an indent 145 defined therein. The indent 145 can be shaped to receive a correspondingly-shaped retention member 130 to temporarily retain the saddle 125 within the saddle base 115. The engagement member 140 may be a shaft leading to or extending from a lift portion 150 having a lift point interface 155 corresponding to a lift point of the vehicle being lifted by the jack 100. For example, the lift point interface 155 can be a standard type saddle to interface with various makes or models of automobiles, as illustrated in FIG. 2. Other saddles can include more traditional and universal lift point interfaces to interface with different makes or models of vehicles, and/or specific lift point interfaces to interface with certain makes of vehicles, for example, as described below with reference to FIGS. 6A-11B.

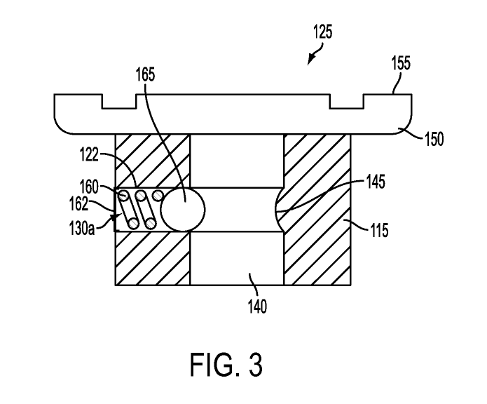

FIG. 3 illustrates one embodiment of the present application including a retention member 130a applying a spring-biased ball detent force to the indent 145 on the engagement member 140 of the saddle 125. As illustrated, the retention member 130a includes a spring 160 disposed within the saddle base 115, for example, in the side opening 122, wherein the side opening 122 is closed on its outer end by a cap 162. The cap 162 may be welded to the base 115 and/or may be an integral part of the base 115. The side opening 122 may also be a blind hole extending from an interior of the saddle base 115 into the side of the saddle base 115.

The spring 160 spring biases a ball 165 toward an interior of the saddle base 115 and against or into detainable engagement with the indent 145 of the saddle 125. The saddle 125 can therefore be easily inserted into the opening 120 of the saddle base 115, and removably retained within the saddle base 115 by the retention member 130a. Likewise, the saddle 125 can be easily removed from the saddle base 115 by simply lifting the saddle 125 against the force of the spring 160 and ball 165.

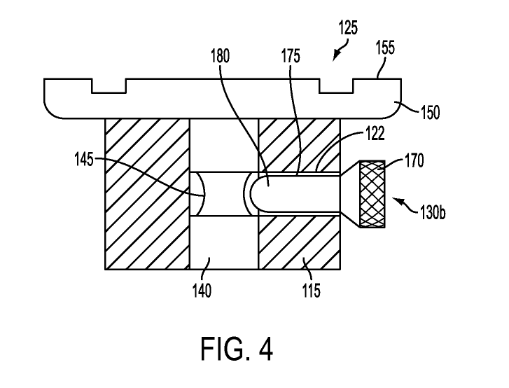

FIG. 4 illustrates another embodiment of a retention member 130b according to the present application. As illustrated, the retention member 130b includes a turn knob 170 coupled to a pin 175 having a ball point 180. The pin 175 may be inserted into and/or extend into the saddle base 115, for example, in the side opening 122, with the ball point 180 adapted to engage the indent 145 of the saddle 125 in the interior of the saddle base 115. The turn knob 170 may be disposed on an exterior of the saddle base 115 to allow a user to manipulate the turn knob 170.

The turn knob 170 is configured to move the ball point 180 into and out of engagement with the indent 145. For example, rotation of the turn knob 170 in a first direction causes the ball point 180 to move toward the interior of the saddle base 115 and engage the indent 145 of the saddle 125, and rotation of the turn knob 170 in a second direction (opposite the first direction) causes the ball point 180 to move away from the interior of the saddle base 115 and disengage from the indent 145 of the saddle 125. This allows the saddle 125 to be selectively coupled to and removed from the saddle base 115 in a cam-lock fashion.

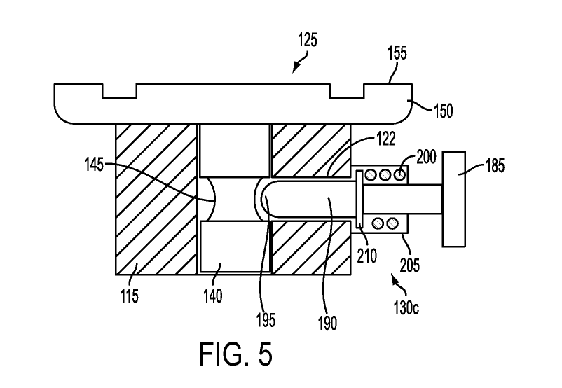

FIG. 5 illustrates another embodiment of a retention member 130c in accordance with the present application. As illustrated, the retention member 130c includes a head 185 coupled to a pin 190 having a ball point 195 that is biased against the indent 145 by a coil spring 200 located within a housing 205. A flange 210 can be disposed on the pin 190 to prevent the pin 190 from moving or shifting too far into the side opening 122.

As illustrated, the pin 190 extends into the side opening 122 and the ball point 195 is adapted to engage the indent 145. The head 185 is couple to the pin 190 opposite the ball point 195 and disposed on an exterior of the saddle base 115 to allow a user to manipulate the head 185. The housing 205 is disposed around the pin 190 between the head 185 and the ball point 195 and may be coupled to an exterior of the saddle base 115. The flange 210 is coupled to the pin 190 between the head 185 and the ball point 195, and disposed in the housing 205. The spring 200 is disposed in the housing and biases the flange 210 against the exterior of the saddle base 115. For example, the coil spring 200 can bias the flange 210, and by extension, the pin 190 toward an interior of the saddle base 115 and into engagement with the indent 145. By pulling on the head 185 to move the head in a direction away from the saddle base 115 causes the retention member 130c to disengage from the indent 145, and allows the user to replace the saddle 125 with a different saddle configured for a different make of vehicle.

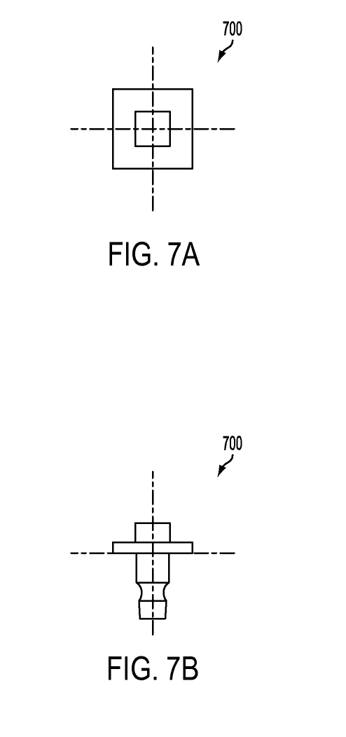

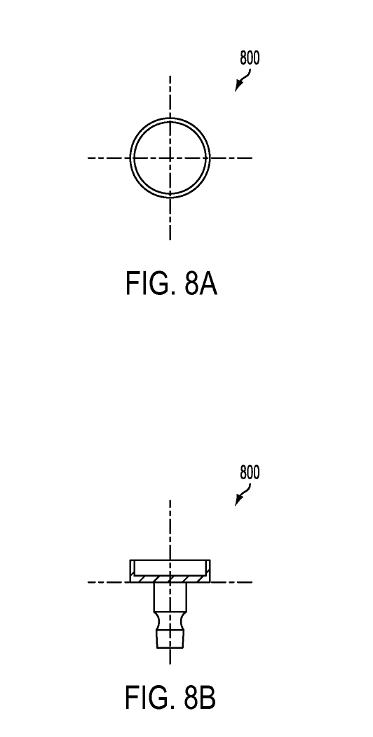

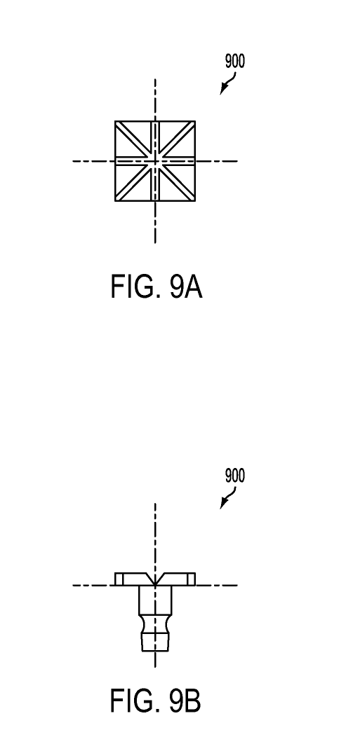

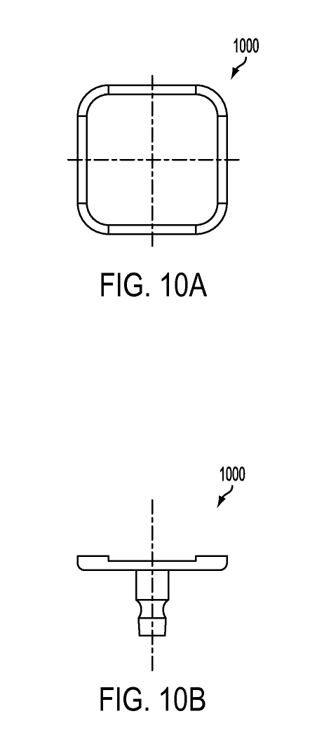

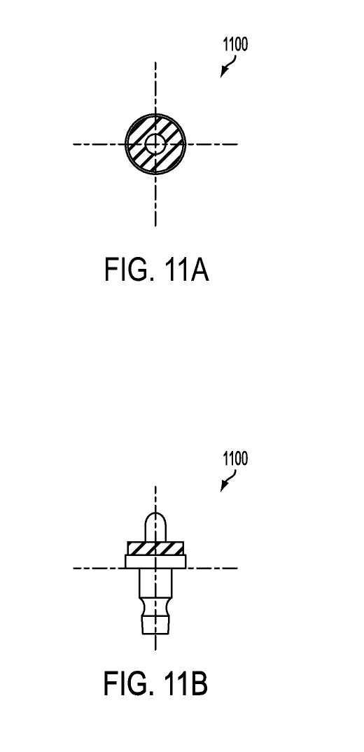

FIGS. 6A-11B illustrate embodiments of exemplar saddles according to the present application. These illustrations demonstrate how diverse floor jack saddles have become, and the need for a floor jack saddle that is interchangeable without the requirement for special tools or complicated processes. For example, FIGS. 6A and 6B illustrate an examplar saddle 600 having a lift point interface for use with vehicles of an Audi make. FIGS. 7A and 7B illustrate an examplar saddle 700 having a lift point interface for use with vehicles of BMW, Mini and Nissan makes. FIGS. 8A and 8B illustrate an exemplar saddle 800 having a lift point interface for use with vehicles of a Mercedes make. FIGS. 9A and 9B illustrate an examplar saddle 900 having a pinch weld type lift point interface that can be used with various vehicles. FIGS. 10A and 10B illustrate an exemplar saddle 1000 having a standard type lift point interface that can also be used with various vehicles. Further, FIGS. 11A and 11B illustrate an exemplar saddle 1100 having a lift point interface for use with vehicles of Corvette or General Motors makes. It will be appreciated that the exemplar saddles depicted and described herein are for exemplary purposes only, and any type of saddle adapted to lift vehicles or other items can be used without departing from the scope and sprit of the present application.

Accordingly, the saddles illustrated in FIGS. 6A-11B can include an indent 145 capable of receiving a retention member 130 (including retention members 130a, 130b, or 130c) to removably couple the saddles to the saddle base 115 of the jack 100. This allows the user to easily change the saddle 125 to a different saddle to suit the make of vehicle or item being raised or lifted, and can match the lift point interface of the saddle with the corresponding interface on the vehicle or item.

The matter set forth in the foregoing description and accompanying drawings is offered by way of illustration only and not as a limitation. While particular embodiments have been described and illustrated, it will be apparent to those skilled in the art that changes and modifications may be made without departing from the broader aspects of Applicant's contribution. For example, while the examples described above relate to a floor jack, the retention members and saddles described herein may be integrated into any type of jack used to lift a vehicle. The actual scope of the protection sought is intended to be defined in the claims of the present application when viewed in their proper perspective based on the prior art.

What is claimed is:

1. A jack, comprising:
a frame;
a jacking mechanism coupled to the frame including a handle and a lifting arm movable relative to the frame in response to movement of the handle;
a saddle base coupled to the lifting arm;
a saddle adapted to be removably coupled to the saddle base and including:
a lift portion including a lift point interface adapted to engage a lift point of an item to be lifted; and
an engagement member extending from the lift portion and including an indent adapted to engage a retention member in the saddle base to removably couple the saddle to the saddle base.

2. The jack of claim 1, wherein the retention member includes a ball and a spring adapted to bias the ball into detainable engagement with the indent.

3. The jack of claim 2, wherein the saddle base includes:
a first opening adapted to receive the engagement member; and
a second opening in an interior side of the saddle base adapted to receive the ball and spring.

4. The jack of claim 1, wherein the retention member includes:
a pin extending into the saddle base and adapted to engage the indent; and
a knob coupled to the pin, the knob being adapted to move the pin into engagement with the indent in response to rotation of the knob in a first direction, and move the pin out of engagement with the indent in response to rotation of the knob in a second direction.

5. The jack of claim 4, wherein the saddle base includes:
a first opening adapted to receive the engagement member; and
a second opening in a side of the saddle base and angularly displaced with respect to the first opening, the second opening being adapted to receive the pin.

6. The jack of claim 1, wherein the retention member includes:
a pin extending into the saddle base and adapted to engage the indent;
a knob coupled to the pin; and
a spring adapted to bias the pin into engagement with the indent, wherein the knob is adapted to move the pin out of engagement with the indent in response to movement of the knob in a direction away from the indent.

7. The jack of claim 6, wherein the saddle base includes:
a first opening adapted to receive the engagement member; and
a second opening in a side of the saddle base and angularly displaced with respect to the first opening, the second opening being adapted to receive the pin.

8. The jack of claim 6, wherein the retention member further includes a housing disposed around the pin, and wherein the spring is disposed in the housing.

9. The jack of claim 8, wherein the retention member further includes a flange portion on the pin and adapted to limit movement of the pin into the saddle base, and wherein the spring is adapted to bias the flange portion toward the saddle base.

10. The jack of claim 1, wherein the lift point interface is a pinch weld lift point interface.

11. The jack of claim 1, wherein the lift point interface is a standard lift point interface.

12. The jack of claim 1, wherein the saddle is one of a plurality of saddles, wherein each of the saddles includes a different lift point interface.

13. A mechanism for use in interchanging saddles of a jack, comprising:
a detent retention mechanism in a saddle base of the jack; and
a saddle adapted to engage the detent retention mechanism and removably couple the saddle to the saddle base, the saddle including:
a lift portion including a lift point interface adapted to engage a lift point of a vehicle; and
an engagement member extending from the lift portion and adapted to engage the detent retention mechanism and removably couple the saddle to the saddle base.

14. The mechanism of claim 13, wherein the detent retention mechanism includes a ball and a spring adapted to bias the ball into engagement with the engagement member.

15. The mechanism of claim 13, wherein the detent retention mechanism includes:
a pin adapted to engage the engagement member; and
a knob coupled to the pin, the knob being adapted to move the pin into engagement with the engagement member in response to rotation of the knob in a first direction, and move the pin out of engagement with the engagement member in response to rotation of the knob in a second direction.

16. The mechanism of claim 13, wherein the detent retention mechanism includes:
a pin adapted to engage the engagement member;
a knob coupled to the pin; and
a spring adapted to bias the pin into engagement with the engagement member, wherein the knob is adapted to move the pin out of engagement with the engagement member in response to movement of the knob in a direction away from the engagement member.

17. The mechanism of claim 16, wherein the detent retention mechanism further includes a housing disposed around the pin, and wherein the spring is disposed in the housing.

18. The mechanism of claim 17, wherein the detent retention mechanism further includes a flange portion on the pin, and wherein the spring is adapted to bias the flange portion thereby biasing the pin into engagement with the engagement member.

19. The mechanism of claim 13, wherein the lift point interface is a pinch weld lift point interface.

20. The mechanism of claim 13, wherein the saddle is one of a plurality of saddles, wherein each of the saddles includes a different lift point interface.
